(19) United States
(12) Patent Application Publication
(10) Pub. No.: US 2005/0021792 A1
(43) Pub. Date: Jan. 27, 2005

(54) Method for managing data sharing among application programs

(76) Inventors: Masakazu Nishida, Yokosuka-shi (JP); Nobuyuki Watanabe, Sayama-shi (JP); Masayuki Tsuda, Tokyo (JP); Yasunori Hattori, Fujisawa-shi (JP); Mao Asai, Yokosuka-shi (JP); Naoki Naruse, Yokohama-shi (JP); Yuichi Ichikawa, Yokosuka-shi (JP); Atsuki Tomioka, Yokohama-shi (JP); Masato Takeshita, Tokyo (JP); Kazuhiro Yamada, Yokohama-shi (JP); Satoshi Washio, Tokyo (JP); Dai Kamiya, Tokyo (JP); Naoki Yamane, Tokyo (JP); Keiichi Murakami, Ichikawa-shi (JP)

Correspondence Address: Brinks Hofer Gilson & Lione;NBC Tower, Suite 3600, P.O. Box 10395, Chicago, IL, 60610, US

(21) Appl. No.: 10/810,500

(22) Filed: Mar. 26, 2004

(30) Foreign Application Priority Data
Mar. 28, 2003 (JP) 2003-091527

(51) Int. Cl. G06F 15/16

(52) U.S. Cl. 709/229

(57) ABSTRACT

A mobile phone compares a URL of a provider of an original Java application (JavaAP) with a URL of a provider of a destination JavaAP, to determine whether a FQDN (Fully Qualified Domain Name) of the URLs are identical. Only if the FQDNs are identical, the mobile phone permits the destination JavaAP to use data relating to the original JavaAP. In this way, appropriate management of transferring data from an application to another will be effected, thereby improving data security against an unauthorized application.

This application claims priority under 35 U.S.C. § 119 to Japanese Patent Application No. 2003-091527 filed Mar. 28, 2003, the entire content of which is hereby incorporated by reference.

### TECHNICAL FIELD

The present invention relates to a method for managing, transferring and sharing of data among programs.

### BACKGROUND ART

As is well known, a computer such as a PC executes application programs installed in the computer to perform word processing, Internet browsing, e-mail communication, and the like. It is to be noted that some types of computer data generated by such application programs, can be used by other programs. In other words, data can be shared among a plurality of programs run on a computer. An example of a data sharing technique is disclosed in Japanese Patent Application No. 2002-312215.

A PC or mobile phone capable of carrying out packet communication can download a program from a WWW (World Wide Web) server via the Internet. The Internet is open to the public, and thus anyone can upload a program without restriction. Therefore, a problem arises in that a destructive or harmful program, for example, a “Trojan horse” or “Backdoor” can sneak data or personal information out of a user terminal, or cause a malfunction when accidentally downloaded to a user's computer.

Therefore, if a computer allows, without any restriction, a program to use program-oriented data, which is generated or used during execution of another program, some problems will arise as described below. For example, when executing a program, that may have been provided by a malicious hacker, personal information input by a user is illicitly taken from the user's computer. It is also possible for data used along with an authorized program to be interfered with by other programs that are either destructive or defective.

To overcome the above problems relating to data security with respect to other programs, one option is to prohibit sharing of all data among various programs installed within a computer. In this case, however, usability or functionality of a computer is greatly reduced.

### DISCLOSURE OF THE INVENTION

The present invention has been made to overcome the above problems. An object of the present invention is to manage transferring or sharing program-related data among other programs while retaining security of the data.

A computer terminal of the present invention comprises: a receiving means for receiving a program; a storage means for storing correspondingly a program and provider identification of the program; an executing means for executing a program, the program stored in the storage means, the storage means storing at least first and second programs; a determining means for determining whether the provider identifications of the first program and the second program that are stored in the storage means are the same, the determination being carried out in response to a request for allowing the use of data with the second program, the data being associated with the first program, and the data being able to be used with the first program; and a permitting means for permitting the use of data with the first program if the determining means determines that provider identifications are the same.

In another aspect, the present invention provides a computer program product for causing a computer to execute the steps of: storing correspondingly a program received by the computer and provider identification of the program to a memory; executing a program, the program stored in the storage means, the storage means storing at least first and second programs; determining whether the provider identifications of the first program and the second program that are stored in the memory are the same, the determination carried out in response to a request for allowing the use of data with the second program, the data being associated with the first program, and the data being able to be used with the first program; and permitting the use of data with the first program if the provider identifications of the two programs are the same.

It is possible that the above computer program product is stored in a computer readable storage medium.

In the present invention, the second program is allowed to use the data that is related to the first program, only if providers of the first and the second program are the same.

### BRIEF DESCRIPTION OF THE DRAWINGS

FIG. 1 shows a configuration of a communication terminal of an embodiment of the present invention.

FIG. 2 shows a configuration of a JavaAP.

FIG. 3 shows a hardware configuration of a mobile phone.

FIG. 4 shows a configuration of a JAR storage.

FIG. 5 shows a configuration of a scratch pad.

FIG. 6 shows an execution environment of a mobile phone.

FIG. 7 shows a processing flow of operations of downloading a JavaAP, which are performed by the mobile phone and a content server.

FIG. 8 shows a processing flow performed by a launch API executed by the mobile phone.

FIG. 9 shows a processing flow of registration of JavaAP performed by a mobile phone in a modified embodiment.

### DETAILED DESCRIPTION OF THE DRAWINGS AND THE PRESENTLY PREFERRED EMBODIMENTS

A preferred embodiment of the present invention, referring to the accompanying drawings will be described. It is to be noted that like numerals are assigned to like elements in the drawings.

A. Configuration

1. Communication System

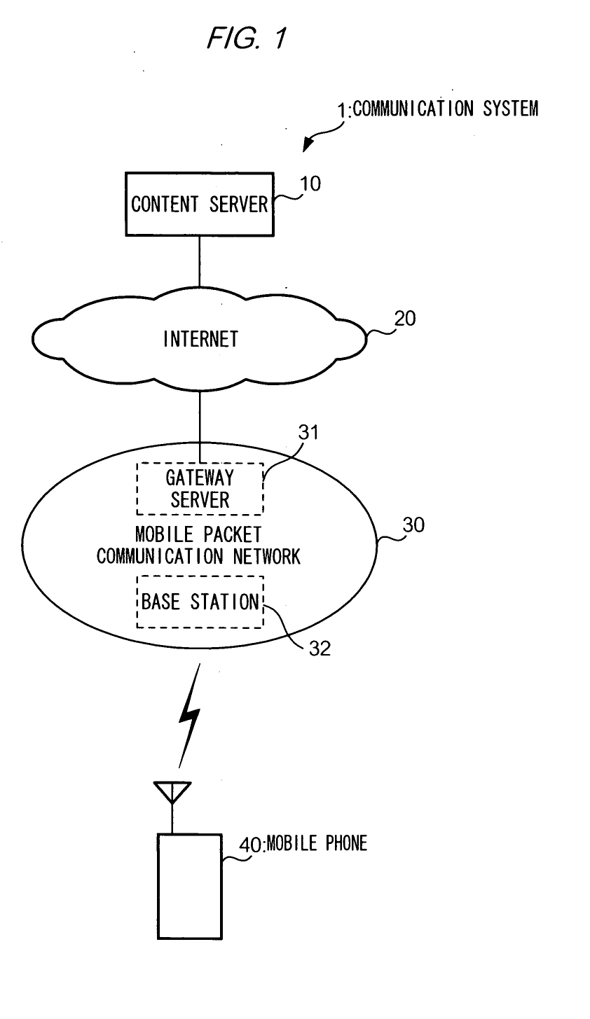

FIG. 1 shows an overall configuration of a communication system 1 of the embodiment. As shown, communication system 1 includes a content server 10, Internet 20, mobile packet communication network 30, and mobile phone 40.

Content server 10 is capable of carrying out communication with mobile phone 40 via mobile packet communication network 30. A JavaTM application software, (hereinafter referred simply to as “a JavaAP”) is stored in content server 10, by which the program can be executed in mobile phone 40.

Mobile packet communication network 30 includes a gateway server 31 and base stations 32. Gateway server 31 performs protocol exchange to relay data between mobile packet 30 and Internet 20. Each of base stations 32 is provided in a commutation service area established in mobile packet communication network 30. Each of base stations 32 in an area (radio cell) carries out communication with mobile phone 40 located in the area.

Mobile phone 40 is a mobile phone accommodated to mobile packet communication network 30. Mobile phone 40 is capable of performing communication with content server 10 via one of base stations 32, to download a JavaAP from content server 10.

2. JavaAP

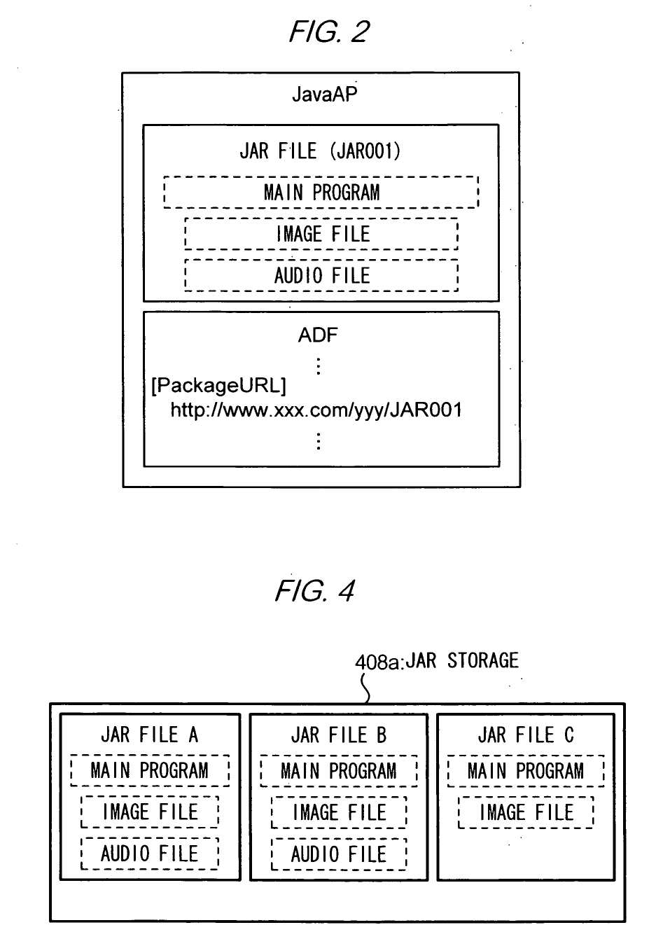

FIG. 2 is a conceptual diagram showing a configuration of a JavaAP stored in content server 10. As shown in the figure, a JavaAP is comprised of a JAR (Java Archive) file and ADF (Application Descriptor File). A JAR file is a bundle of files including a main program (sometimes referred to “a Java application program” or “JavaAPP”) and picture data file, audio data file, which are used with the main program. An ADF stores control information for controlling the installation and executing of a JAR file and communicating with an electronic device via a network, and the like.

Specifically, an ADF is a data file that is downloaded to mobile phone 40, prior to downloading a JAR file. Since a JAR file and the corresponding ADF are necessarily downloaded and used in pairs, a URL (Uniform Resource Locator) which indicates a location of JAR file in Internet 20 is included in the ADF as a data item “PackageURL”, to thereby associate the ADF with the JAR file. “PackageURL” data of a JavaAP is written by a provider (sender) of JavaAP.

Referring to FIG. 2, “http://www.xxx.com/yyy/JAR001” is included in the “PackageURL”. Thus, mobile phone 40 can obtain a JAR file “JAR001” which is associated with the ADF from a WWW server (content server 10) identified by the URL “http://www.xxx.com/yyy/JAR001”.

In the following description, a JAR file and an ADF are referred to simply as a JavaAP, except where the JAR file and the ADF need to be distinguished. Also, a JAR file and the corresponding ADF that are comprised of a single JavaAP should be stored in content server 10. However, in another embodiment it is possible that a JAR file and ADF may be stored in different servers.

3. Mobile Phone

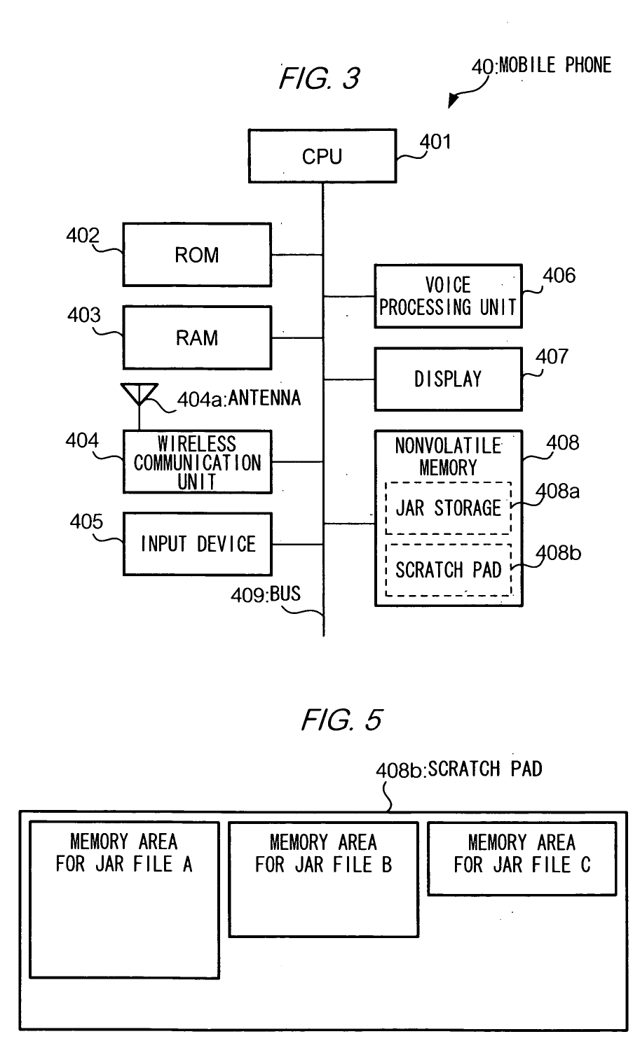

FIG. 3 is a block diagram showing a hardware configuration of mobile phone 40. As shown in FIG. 3, mobile phone 40 includes a CPU 401, ROM 402, RAM 403, wireless communication unit 404, input device 405, voice processing unit 406, liquid crystal display 407, nonvolatile memory 408, and bus 409 that connects every unit of mobile phone 40.

CPU 401 executes a program stored in ROM 402 or nonvolatile memory 408 to control every unit of the mobile phone. ROM 402 stores a program for performing basic control of the above units of the mobile phone. RAM 403 is used by CPU 401 as a work area.

Wireless communication unit 404 includes an antenna 404a for performing wireless communication with base station 32. Specifically, wireless communication unit 404 creates, under control of CPU 401, a signal on the basis of packet communication data or voice communication data by modulating a carrier wave, and transmits the signal to base station 32 using a carrier wave. Wireless communication unit 404 receives a signal from base station 32 via antenna 404, and demodulates the signal to obtain packet communication data or voice communication data.

Input device 405 includes a keypad which enables a user to input a number, character, and some instructions. Input device 405 outputs a signal to CPU 401 according to a user's operation. Voice processing unit 406 includes a microphone, speaker, voice coding/decoding unit, and the like, which performs, under control of CPU 401, a processing related to communication such as call connection and termination controls. Liquid crystal display 407 includes a display panel and a drive circuit for the panel.

Nonvolatile memory 408 is a SRAM (Static-RAM), EEPROM (Electrically Erasable Programmable-ROM), or the like, which stores operating system software (hereinafter referred to simply as “an OS”), WWW browser program, program(s) for setting up a Java execution environment. In addition, nonvolatile memory 408 stores a JavaAP and other programs downloaded from content server 10.

Nonvolatile memory 408 includes a JAR storage 408a and scratch pad 408b. A plurality of JAR files are stored in JAR storage 408a in a manner shown in FIG. 4. Referring to the figure, three JAR files “JAR file A”, “JAR file B”, and “JAR file C” are stored in JAR storage 408a.

Referring to FIG. 5, memory areas assigned to JAR files are provided, each area storing data which is created by a main program of the JAR file. For example, in a case where a JavaAP is a game application, the data may be game data for future use, which is created when a user leaves the game.

4. Execution Environment in Mobile Phone

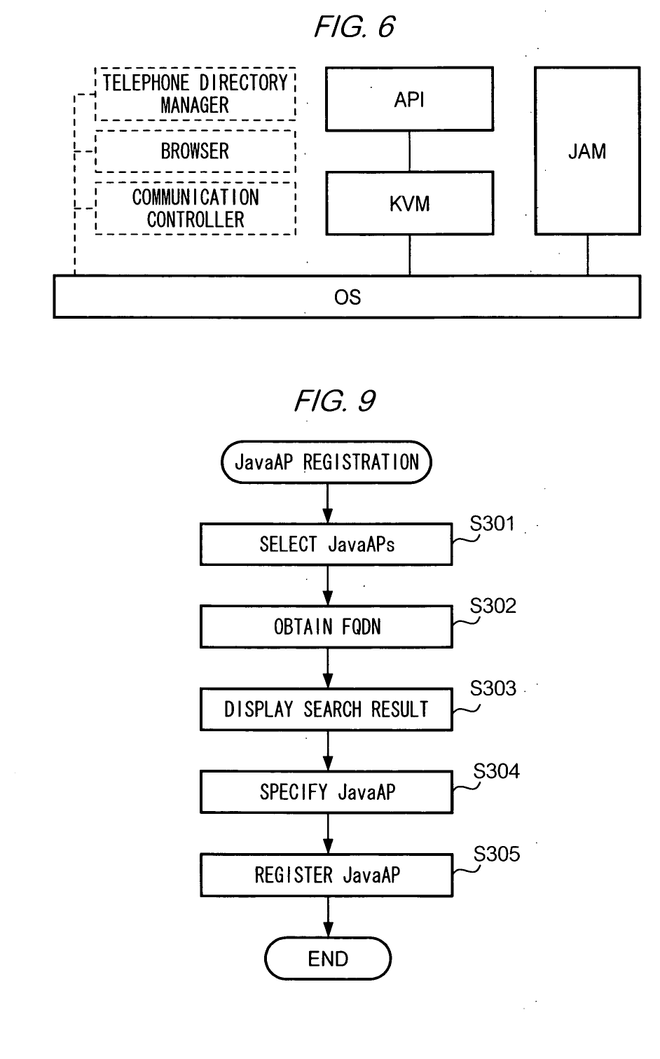

FIG. 6 shows an execution environment set up in mobile phone 40. In the figure, KVM (K Virtual Machine) is a kind of JVM (Java Virtual Machine), which is software for converting Java byte-codes to instruction codes, enabling CPU 401 running the OS to interpret and execute it. An API (Application Program Interface) is a software module for providing to a JavaAP a function defined by CLDC (Connected Limited Device Configuration) and other functions particular to mobile phone 40.

JAM (Java Application Manager) is software for performing under control of the OS, the functions of downloading, installation, execution, and termination of a JavaAP. For example, in a case where the main program of JAR file A shown in FIG. 4 is executed, when a request for accessing resources such as nonvolatile memory 408 and ROM 402 is generated, JAM permits the request only if a requested resource is in any of the following memory areas: an area of JAR storage 408a in which JAR file A is stored; an area of scratch pad 408b assigned to JAR file A; a memory area of RAM 403, which is reserved for executing JAR file A (hereinafter referred to as an AP execution area); and content server 10 from which mobile phone 40 has downloaded Java file A.

Simply put, JAM has a capability of preventing other JavaAPs from using data relating to JavaAPs, by restricting access to resources performed by other JavaAPs when JavaAP is being executed.

It is to be noted that software other than a JavaAP for maintaining a telephone directory, internet browsing, and data communication is executed directly under control of the OS, as shown in FIG. 6.

B. Operation

1. Download of JavaAP

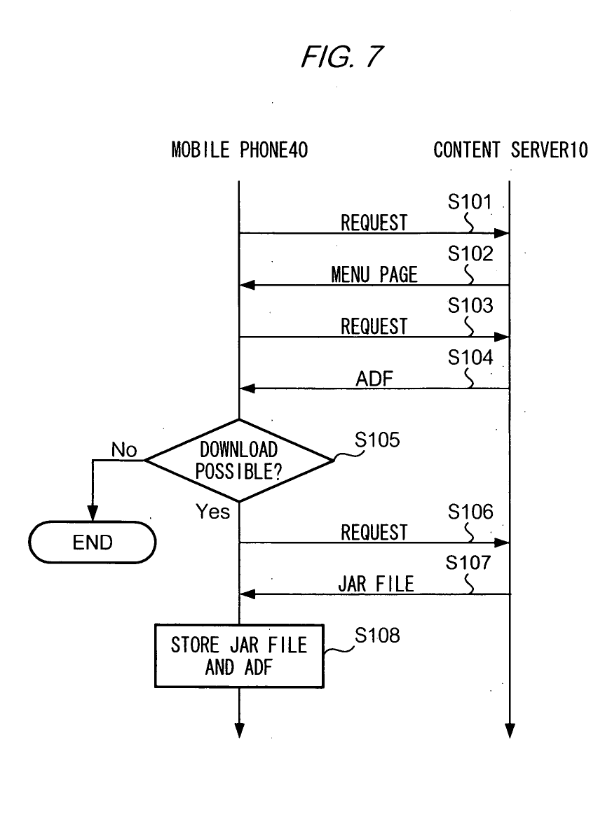

FIG. 7 is a processing flow of downloading a JavaAP performed by mobile phone 40 and content server 10. Processing of step 103 and later performed by mobile phone 40 is performed by JAM.

First, a user of mobile phone 40 executes the WWW browser via input device 405. Next, the user inputs via input device 405 an instruction to access content server 10. Accordingly, a request message for connecting to content server 10 is transmitted from mobile phone 40 to content server 10 (step S101). Upon receipt of the request message, content server 10 performs a predetermined authentication of mobile phone 40 and then transmits data of a menu page of a website run by content server 10 (step 102). Upon receipt of the data, mobile phone 40 displays an image on display 407. Subsequently, information including a selected item displayed on the menu page is exchanged between mobile phone 40 and content server 10.

When a user watching the menu page selects a JavaAP which the user wishes to download, CPU 401 transmits to content server 10 a request message requesting an ADF of the selected JavaAP (step S103). Upon receipt of the message, content server 10 specifies and reads the ADF from memory; and then transmits the ADF to mobile phone 40 (step S104).

Upon receipt of the ADF, CPU 401 checks contents of the ADF (files included in the ADF), to determine whether a size of JAR file associated with the ADF is small compared to the amount of available storage space of mobile phone 40 (step S105). Specifically, CPU 401 reads “AppSize” data and “SPsize” data from the ADF, and checks the amount of available space of JAR storage 408a and scratch pad 408b.

“AppSize” describes a size of a JAR file to be downloaded, which size is a storage space of the JAR file required for storing the JAR file to JAR storage 408a. “SPsize” describes the extent of available storage space of scratch pad 408b assigned to a JAR file to be downloaded. If available storage space in either JAR storage 408a or scratch pad 408b is not adequate for the selected JavaAP, CPU 401 determines that mobile phone 40 cannot download the JAR file due to shortage of memory space, displays a message on display 407 to notify a user of a failure in downloading, and then stops downloading.

If CPU 401 determines that mobile phone 40 is capable of downloading the JAR file (step S105, YES), CPU 401 identifies content server 10 using “PackageURL” data included in the ADF, which data represents a location of the JAR file, and creates a request message to transmit to content server 10 (step S106). Upon receipt of the message, content server 10 identifies the ADF, reads the JAR file from the memory of the server, and then transmits the JAR file to mobile phone 40 (step S107).

Upon receipt of the JAR file, mobile phone 40 first reads “AppSize” data of the ADF. Next, CPU 401 reserves a memory area in JAR storage 408a, the space specified by the “AppSize” data, and then installs the JAR file in the reserved area. Next, CPU 401 reads “Spsize” data from the ADF and reserves a memory area in scratch pad 408b according to the “SPsize” data used with the JAR file. Next, CPU 401 stores the ADF in nonvolatile memory 408 in association with the JAR file (step S108).

2. Execution of JavaAP

When a JavaAP is selected by means of, for example, an instruction of a user watching a list of JavaAPs displayed on display 407, CPU 401 reads a main program of the selected JavaAP from JAR storage 408a and executes it. After the execution, some processing with the JavaAP is performed on the mobile phone. It is possible that a JavaAP is automatically executed when a preset time comes. Further, it is possible that an instruction of the execution is supplied by other running programs. Still further, it is possible that such an instruction may be supplied via e-mail by an electronic device other than mobile phone 40.

When an instruction of executing a JavaAP is input, the AP execution area is reserved for the JavaAP in RAM 403. Specifically, the AP execution area stores a main program read from JAR storage 408a, objects necessary for the execution, and other data created prior to the execution is reserved in RAM 403. After the execution of JavaAP, CPU 401 prohibits, under control of JAM, the currently running JavaAP from accessing data used for other JavaAPs, as described above.

When CPU 401 receives a request for executing another JavaAP stored in nonvolatile memory 408 in a case where processing with the JavaAP is performed on mobile phone 40, CPU 401 executes an API for executing another API (hereinafter referred to as “a launch API”). When the launch API is started, a memory area for the launch API (hereinafter referred to as a launch area is reserved in RAM 403, to which area only the launch API among other APIs is allowed to access.

3. Processing with Launch API

FIG. 3 shows a flowchart describing an example of processing performed by CPU 401 with launch API. As shown in the figure, CPU 401 first obtains “PackageURL” data from an ADF of a currently running JavaAP (hereinafter referred to as “an original JavaAP”, which is stored in nonvolatile memory 408 (step S201). It is to be noted that the “PackageURL” data represents a location (URL) of the original JavaAP. Next, CPU 401 obtains “PackageURL” data from an ADF of a JavaAP which is selected for execution (hereinafter referred to as “a destination JavaAP”) (step S202).

Next, CPU 401 compares two FQDNs (Fully Qualified Domain Names) of the URLs obtained in steps S201 and S202 (step S203), to determine whether the FQDNs are identical (step S204). Namely, originations (providers) of the original JavaAP and the destination JavaAP are checked. If the FQDNs are not identical, CPU 401 displays a message on display 407 to notify a user of a failure of executing the destination JavaAPs (step S205), and then stops executing destination JavaAP (step S206). In this way, launch API is completed.

If the FQDNs are identical (step S294, YES), CPU 401 determines whether the destination JavaAP is permitted to operate with other JavaAPs (step S207). Specifically, an ADF of a JavaAP includes “LaunchApp” data, which represents whether or not the JavaAP is permitted to operate with other JavaAPs. “LaunchApp” data is set by a provider of the JavaAP. For example, “LaunchApp” data is set to “1” for a JavaAP which is permitted to operate with other JavaAPs (hereinafter referred to as “a cooperative JavaAP”), and “0” is set for a JavaAP which is prohibited to operate with other JavaAPs. It is possible to include in “LaunchApp” additional information such as identification of the cooperative JavaAP(s).

CPU 401 obtains “LaunchApp” data from the ADF stored in nonvolatile memory 408 and determines whether the destination JavaAP is a cooperative JavaAP referring to the “LaunchApp” data (“1” or “0”). If the destination JavaAP is not a cooperative JavaAP (step 207, NO), CPU 401 displays a message to notify the user of a failure of executing the destination JavaAP (step S205), and stops executing the destination JavaAP (step S206).

If the destination JavaAP is a cooperative JavaAP (step 207, YES), CPU 401 determines whether data requested by the destination JavaAP is data used with the original JavaAP (step S208). The data is, for example, parameters and other processing results that are generated during execution of the original JavaAP. It is possible that the data may be image data or audio data which are stored in a JAR file of the original application.

If the destination JavaAP does not request the data in step S208, CPU 401 terminates the original JavaAP. Next, CPU 401 reads a main program of the destination JavaAP from JAR storage 408a and executes it (step S209). In this way the launch API is finished. If the destination JavaAP requests data in step S208, CPU 401 displays an inquiry message on display 407 asking the user whether a transfer of the data to the original JavaAP is permitted.

If the user inputs an instruction to prohibit the transfer, or no instruction is input after a predetermined time has passed since the inquiry message was displayed (step S210, NO), CPU 401 does not transfer the data and displays a message on display 407 notifying a user that the destination JavaAP is stopped (step S205) and then quits the destination JavaAP (step S206), to finish the launch API. It is possible that the inquiry message may be a voice created by CPU 401.

If the user inputs an instruction to permit the transfer of data in the predetermined time period after the inquiry message is displayed (step S210, YES), CPU 401 extracts data from either the AP execution area of RAM 403 or the area of scratch pad 408b assigned to the original JavaAP, and stores the extracted data in the launch area of RAM 403 (step S211). Next, CPU 401 terminates the original JavaAP and deletes data stored in the AP execution area of RAM 403. Finally, CPU 401 reads a main program of the destination JavaAP from JAR storage 408a and executes it (step S212).

After execution of the destination JavaAP, CPU 401 reads the data from the launch area of RAM 403. Next, CPU 401 reads the data in either the AP execution area of RAM 403 reserved for the destination JavaAP or a memory area of scratch pad 408b assigned to the destination JavaAP (step S213), and then finishes the launch API.

From the foregoing, when the destination JavaAP is started, the data used with the original JavaAP is transferred to a memory area (the AP execution area or an area of scratch pad 408 assigned to the destination JavaAP), from which the data can be accessed by destination JavaAP. As a result, the data can be used in processing performed by the destination JavaAP.

An example of JavaAPs will be described below, in which two JavaAPs are provided by a single provider, one being a strategy-oriented baseball simulation game software (hereinafter referred to as “a game JavaAP”), and the other baseball training game software for creating a baseball player and training him to develop his skills (batting, pitching, base running, etc.). The data of the baseball player is available for the game. This software is hereinafter referred to as “a practice JavaAP”). A user of mobile phone 40 downloads the JavaAPs and executes the game JavaAP and the practice JavaAP, to “play” baseball using his baseball player. In this case, FQDNs of the game JavaAP and the practice JavaAP are the same, thus data relating to the baseball players can be transferred from the game JavaAP to the practice JavaAP, or the data can be shared between the above two JavaAPs.

In summary, according to the embodiment, mobile phone 40 enables a destination JavaAP to access program-related data that is used or created with an original JavaAP, only if providers of the original and the destination JavaAPs are the same.

Therefore, even in a case where an unauthorized JavaAP is mistakenly downloaded and executed by mobile phone 40, transfer of data relating to an authorized program to the unauthorized JavaAP is prevented, since the providers of the JavaAPs are checked. Further, in this embodiment, after completion of authentication of the originations (providers) of the JavaAPs (FQDN), a user is requested to give permission of transferring the data. Accordingly, data security and flexibility of data transfer management is further improved.

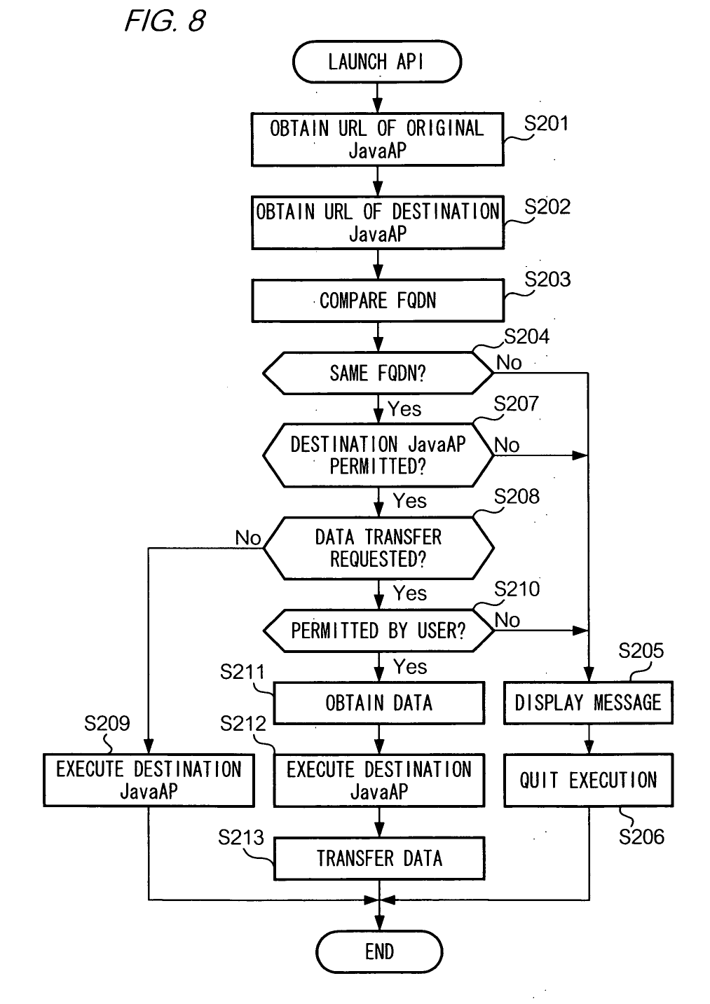

As described in the embodiment, mobile phone 40 executes programs and APIs stored in ROM 402 and nonvolatile memory 408 to perform processing shown in FIGS. 7 and 8. It is possible to provide the above programs and APIs to mobile phone 40 via a communication network. Further, it is possible to provide the above programs and APIs via a computer-readable storage medium such as a floppy disk, CD-ROM, and flash memory.

C. Modifications

### 1. EXAMPLE 1

In the processing with the launch API shown in FIG. 8, it is possible to provide an additional step for determining in advance, whether a user gives permission to exchange data between the original and the destination JavaAPs. In this case, before executing JavaAPs, the user is required to register two or more JavaAPs, between which the user wishes that data be shared.

FIG. 9 shows an example of a processing flow of the above registration performed by CPU 401. The registration processing is started when a user inputs an instruction to register two or more JavaAPs that are permitted to share data among each other.

Referring to the figure, when a user selects a JavaAP among other JavaAPs installed in nonvolatile memory 408 (step S301), CPU 401 obtains a FQDN of the selected JavaAP, referring to a “PackageURL” data included in an ADF of the JavaAP (step S302). Next, CPU 401 searches JavaAP(s) with an FQDN that is the same as the FQDN obtained in step S302 in nonvolatile memory 408. If a JavaAP(s) with the same FQDN is found, CPU 401 displays a list of the found JavaAP(s) on display 407 (step S303).

When the user specifies after referring to the list, a JavaAP(s) permitted to share data with the JavaAP selected in step S301 (step S304), CPU 401 stores in nonvolatile memory 408 corresponding, identifications (filename of a JAR file, for example) of the JavaAP specified in step S304 and the JavaAP selected in step S301 as registration information (step S305). Thus, it is possible to register other JavaAP(s) which are permitted to share data of the JavaAP selected in step S301 is prohibited.

In this example, after completion of the registration, in the processing with the launch API shown in FIG. 8, CPU 401 determines whether transferring data among JavaAPs is permitted in terms of (i) providers of the original and the destination JavaAPs and (ii) prior approval by a user. Namely, the above two conditions are required to be fulfilled to transfer data, thus data security in mobile phone 408 is improved.

### 2. EXAMPLE 2

In the above embodiment, steps S201 through S213 of FIG. 8 are performed by an API (the launch API). However, it is possible to perform those steps by JAM or OS.

### 3. EXAMPLE 3

In the above embodiment, identity of FQDNs shown in step S203 of FIG. 8 is checked using URLs of providers of the original and destination JavaAPs. Hoverer, it is possible to use a domain name of the providers, or other partial URLs (the first 25 characters of the URL, for example) to identify providers, instead of complete URLs. Further, it is possible to extract any part of a URL to use for identification.

In this case, identity of providers of JavaAPs is not necessarily determined in terms of content server 10. As a result, the identity may be determined, for example, in terms of a directory of content server 10 which stores the JavaAP or in terms of a network domain of content server 10. In other words, criteria for identifying the origin of a JavaAP can be set in various ways.

### 4. EXAMPLE 4

In the above embodiment a URL is employed as an identification of an origin (provider) of a program such as a JavaAP. However, it is possible to employ an ID of a computer that provides a program; such as a content server or communication terminal, as the identification. For example, MAC address or e-mail address can be used. Still further, it is possible to employ an ID that is assigned to an author or owner of the program. Still further, it is possible that such an ID is assigned in conformity with a global standard or it can be defined locally by a provider.

Still further, information on providers of a program is not necessarily added to the program. In this case, a computer (mobile phone 40) may receive, from a communication terminal that provides a program, information on a provider of the program (URL and other communication address of the communication terminal), and stores the information in association with the program in a memory of the computer.

In the above embodiment, mobile phone 40 accesses content server 10 to download a JavaAP. However, it is possible that content server 10 broadcasts or multicasts a JavaAP. Further, the present invention can be applied to a PHS (Personal Handyphone System™) terminal, PDA, PC, and other suitable communication terminals other than a mobile phone.

Needless to say, it is possible that a program used in the present invention may be written in a suitable language other than Java.

As is apparent from the foregoing description, a computer system based on the present invention is able to manage transferring or sharing of data among other programs while retaining security of the data.

While the invention will be described in conjunction with the preferred embodiments, it will readily be understood that it is not intended to limit the scope of the invention to these embodiments. On the contrary, the invention is intended to cover alternatives, modifications, and equivalents, which may be included within the spirit and scope of the invention as defined by the appended claims.

1. A computer terminal comprising:
a receiving means for receiving a program;
a storage means for storing correspondingly a program and provider identification of the program;
an executing means for executing the program, the program being stored in said storage means, and said storage means storing at least first and second programs;
a determining means for determining whether the provider identifications of the first program and the second program that are stored in said storage means are the same, the determination being carried out in response to a request for allowing use of data with the second program, the data being associated with the first program, and the data being able to be used with the first program; and
a permitting means for permitting use of the data with the first program if said determining means determines that the provider identifications are the same.

2. The computer terminal of claim 1, further comprising:
a input device for use by a user; and
a requesting means for requesting a user's permission to use the data with the second program,
wherein
upon receipt of permission via said input device, said permitting means permits the use of data with the second program, if said determining means determines the provider identifications of the two programs are the same.

3. The computer terminal of claim 1, further comprising:
a input device used by a user; and
a setting means for setting, on the basis of the instruction input via said input device, the permission to use the data with the second program,
wherein
if the permission is set by said setting means and said determining means determines that the provider identifications are the same, said permitting means permits use of the data with the second program.

4. The computer terminal of claim 1, wherein the provider identification includes a communication address of a communication device which transmits the program.

5. A computer program product for causing a computer to execute the steps of:
storing correspondingly a program received by said computer and a provider identification of the program in a memory;
executing a program, the program being stored in said storage means, said storage means storing at least first and second programs;
determining in response to a request for allowing use of the data with the second program, whether the provider identifications of the first program and the second program that are stored in said memory are the same, the data being associated with the first program, and the data being able to be used with the first program; and
permitting use of the data with the first program if the provider identifications are the same.
